(19) United States
(12) Patent Application Publication
(10) Pub. No.: US 2006/0272594 A1
(43) Pub. Date: Dec. 7, 2006

(54) Therapeutic apparatus and method for animal

(76) Inventors: Kay K. Cox, Chandler, AZ (US); Martha S. Jones, Maricopa, AZ (US)

Correspondence Address: TOD R NISSLE, PO BOX 55630, PHOENIX, AZ, 85078, US

(21) Appl. No.: 11/145,465

(22) Filed: Jun. 2, 2005

(51) Int. Cl. A01K 15/02

(52) U.S. Cl. 119/719

(57) ABSTRACT

A therapeutic apparatus and method are provided for an animal. The method and apparatus appeal simultaneously to multiple ones of an animal's sense of touch, sense of smell, sense of sight, sense of taste, and sense of hearing to soothe, groom, and relax the animal and to improve the animal's disposition.

This invention pertains to therapeutic apparatus and methods for an animal.

More particularly, the invention pertains to an apparatus and method that appeal simultaneously to multiple ones of an animal's sense of touch, sense of smell, sense of sight, sense of taste, and sense of hearing to sooth and relax the animal and to improve the animal's disposition.

In a further respect, the invention pertains to an apparatus that facilitates simultaneously soothing an animal and grooming the animal.

U.S. Pat. Nos. 5,768,709 and 5,577,273 describe a glove used to groom an animal. If desired, a vibrating unit can be mounted on the back of the glove to transmit vibrations through the user's hand and glove to an animal.

U.S. Pat. No. 5,009,195 describes a pliable sheet of material that is wrapped around a user's hand and is used to groom an animal.

The prior art devices described in the afore-mentioned patents are useful, but appear to have disadvantages in certain situations.

First, each of the prior art devices has bristles. When small cats and dogs, or even larger animals, are being groomed, bristles can be uncomfortable to tender skin areas of the animal.

Second, cleaning animal fur from bristles can be relatively time consuming, especially if the animal is shedding.

Third, the appearance of the prior art devices can be alarming to an animal. Many animals have been punished or abused by a human hand. Consequently, when an animal views a human being wearing the prior art devices, the animal may do so with alarm because the animal is uncertain of the action it is about to encounter. This can make it difficult for the animal to relax while being groomed.

Fourth, since the massage unit is mounted on the back of the prior art devices, it is difficult for a user to transmit vibration energy through the fingertips of the user's hand.

Fifth, the prior art devices appear to focus on appealing only to the sense of touch of an animal, and do not focus on appealing to other senses of an animal to facilitate the therapeutic treatment of the animal.

Accordingly, it would be highly desirable to provide an improved therapeutic apparatus and method for an animal that would groom an animal with minimal discomfort, that would require minimal time to clean, and that would simultaneously appeal to multiple ones of the animal's senses to therapeutically treat the animal.

Therefore, it is a principal object of the invention to provide an improved therapeutic apparatus and method for an animal, including animals having a fur coat.

A further object of the invention is to provide an improved therapeutic apparatus and method that would clean an animal's fur and remove excess fur while causing minimal discomfort or causing no discomfort whatsoever.

Another object of the invention is to provide an improved therapeutic device that is easily cleaned to remove dirt, grease, and fur from the device.

Still another object of the invention is to provide an improved therapeutic device that more effectively soothes and relaxes an animal and improves the animal's disposition.

Still a further object of the invention is to provide an improved device that can be utilized to provide simultaneously therapeutic massage and aroma therapy.

Yet another object of the invention is to provide an improved method for massaging, grooming, and cleaning an animal while simultaneously promoting emotional bonding between the animal and its owner, and promoting the development of a contented attitude in the animal.

These and other, further and more specific objects and advantages of the invention will be apparent from the following detailed description of the invention, taken in conjunction with the drawings, in which:

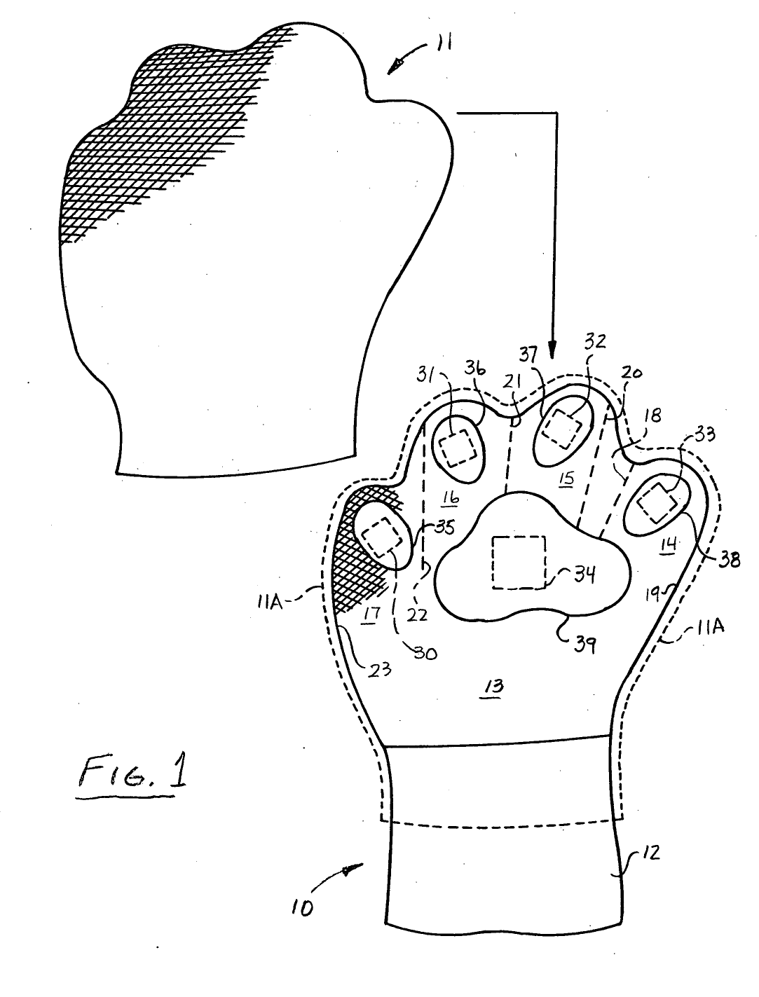

FIG. 1 is an exploded assembly view illustrating a therapeutic device constructed in accordance with the principles of the invention;

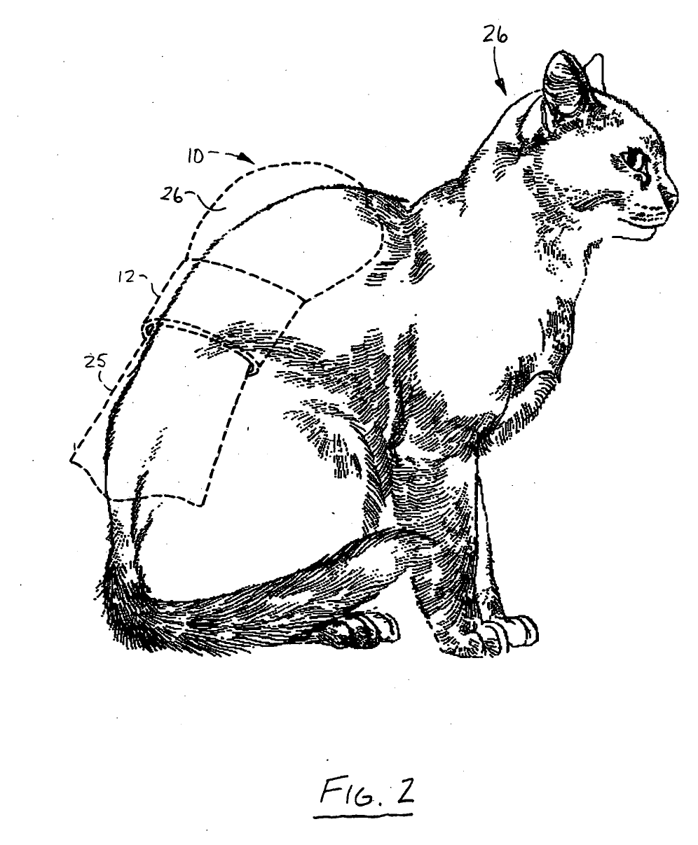

FIG. 2 is a perspective view illustrating mode of operation of the invention;

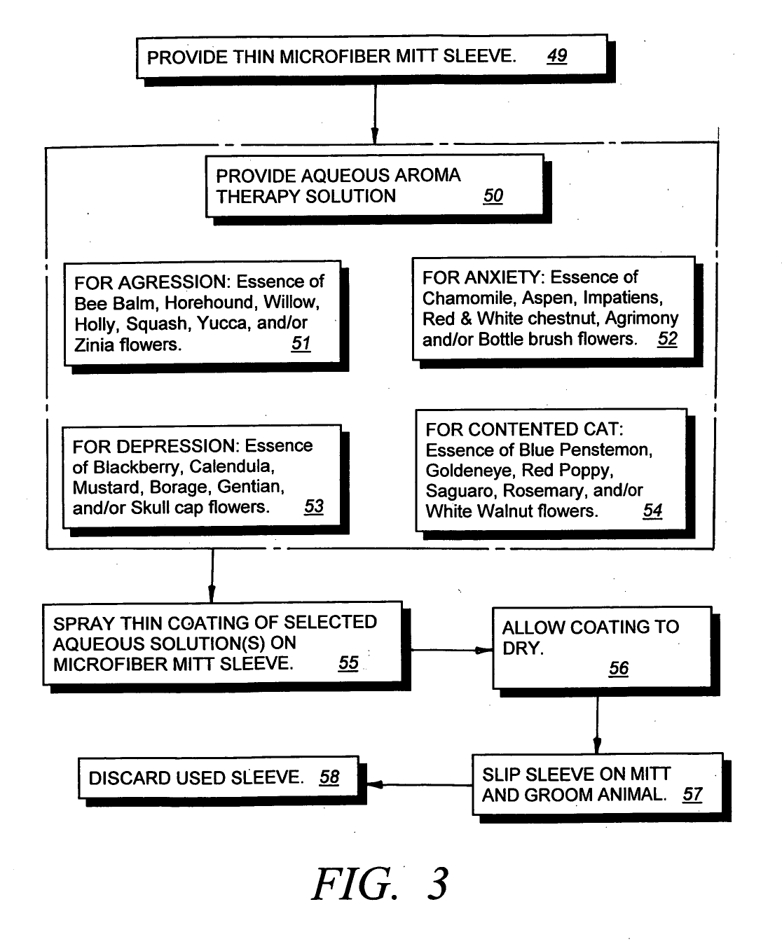

FIG. 3 is a flow chart diagram further illustrating the mode of operation of the invention; and,

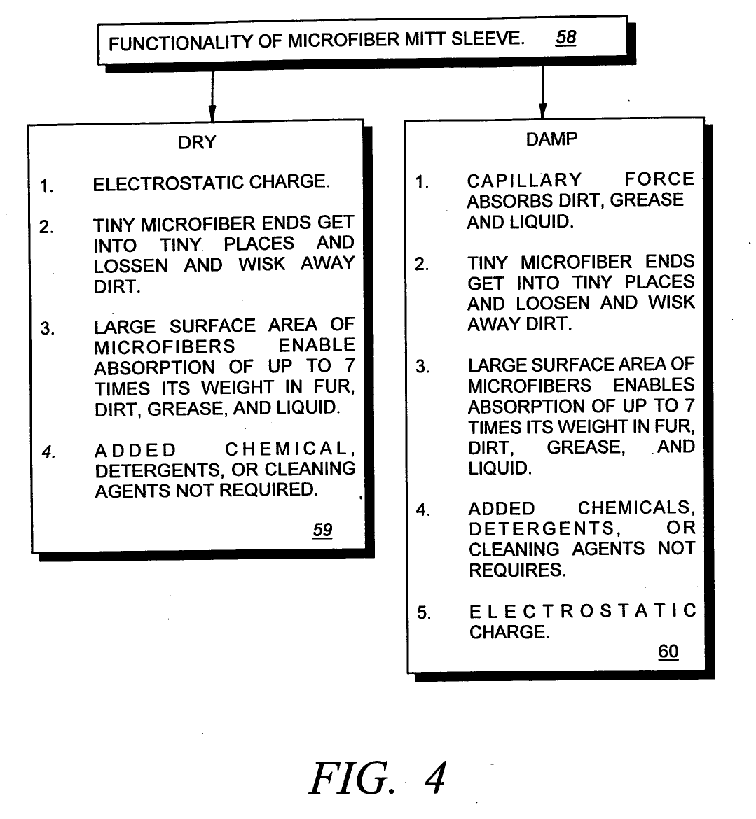

FIG. 4 is a flow chart diagram illustrating functional characteristics of microfiber material that can be utilized in the practice of the invention.

Briefly, in accordance with our invention, we provide an improved therapeutic device to appeal to multiple physical senses of an animal with a fur coat. The device comprises a paw-shaped mitt apparatus; at least one vibrator mounted on the mitt apparatus to produce vibrations detectable by the animal when the mitt apparatus is placed against the animal; at least one audio device mounted on the mitt apparatus to produce a sound having an amplitude that can be heard by the animal, and an amplitude and frequency that is appealing to the animal; and, at least one scent on the mitt apparatus that can be smelled by the animal and that functions to perform at least one function in a group consisting of reducing aggressive behavior of the animal, reducing depression of the animal, and reducing anxiety of the animal.

In another embodiment of the invention, we provide an improved therapeutic device for an animal with a fur coat. The device comprises a paw-shaped mitt apparatus including a front including a palm area and a plurality of toe areas, and a back; at least one vibrator mounted on the mitt adjacent one of the toe areas; at least one vibrator mounted on the mitt adjacent the palm area; and, partitions in the mitt each defining at least in part a stall for at least one finger on the hand of a human being.

In a further embodiment of the invention, we provide an improved therapeutic device to appeal to multiple physical senses of an animal with a fur coat. The device comprises a paw-shaped mitt apparatus including a removable thin outer microfiber sleeve. The sleeve, when dry, attracts fur by electric charge, includes tiny microfiber ends that loosen dirt from an animal's fur, and absorbs up to four times its weight in dirt, grease, and liquid. When damp, the sleeve absorbs dirt, grease and liquid by capillary force; includes tiny microfiber ends that loosen dirt from an animal's fur; absorbs up to four times its weight in dirt, grease, and liquid, and; is comprised of fibers less than one denier. At least one scent on the mitt apparatus can be smelled by the animal and that functions to perform at least one function in a group consisting of reducing aggressive behavior of the animal, and, reducing depression of the animal, reducing anxiety of the animal.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 is an exploded assembly view illustrating a therapeutic device constructed in accordance with the principles of the invention and including a paw-shaped mitt apparatus that includes paw-shaped mitt or glove 10 and a paw-shaped sleeve 11 that generally conforms to and slips over mitt 10 to the position generally indicated by dashed lines 11A. Sleeve 11 is closed at the top and open at the bottom, like a mitt. However, sleeve 11 can, if desired, be open “at either end”, i.e., at the top as well as the bottom; can be open at the bottom and one side; can be open at the bottom, top, and one side; etc. The function of the sleeve 11 is to cover at least a portion of the mitt 10 so the sleeve can perform the function of grooming an animal's fur, of emitting an aroma therapy scent, and/or of appealing to another of the physical senses of an animal.

Sleeve 11 can be fabricated from any desired material, but presently preferably consists of a thin material comprised of microfibers. A microfiber is less than one denier. Denier defines the fineness of a continuous or filament fiber such as silk or man-made fibers. Denier is the weight in grams of a 9000 meter length of a fiber. The higher the denier number, the thicker the fiber. Fine silk is approximately 1.25 denier. A microfiber is 0.9 denier or finer. Many microfibers are 0.5 to 0.6 denier. Microfibers typically are one hundred to two hundred times finer than human hair. Fabric or material made from microfibers has more fibers and more surface area than fabric made from cotton. As a result, when microfiber material is dry a greater electrostatic charge is available to attract dirt. The tiny ends of microfibers get into tiny places and loosen and remove dirt. The larger surface area produced by microfibers allows microfiber fabric to absorb four to seven times its weight in liquid, grease, and dirt. Microfibers typically, although not necessarily, consist of a nylon blend of polyester and polyamide. Microfiber fabric need not included added chemicals, detergents, or cleaning agents, and often can be washed about 600 times without losing its static charge and absorbent power. Alternatively, a used sleeve 11 made from microfibers is, when produced in volume, relatively inexpensive and can be discarded and replaced with a new clean sleeve. When a microfiber sleeve is wetted, capillary forces are activated. These forces work to lock dirt into the weave of the fabric. Since it often is not desirable to use a wet cloth to groom a cat, dog, horse, or other animal with a fur coat, a sleeve 11 fabricated from microfibers can be wetted and wrung out to remove most of the water so that the sleeve 11 is only damp. The functionality of a microfiber mitt sleeve 58 described above when the sleeve is dry 59 and damp 60 is illustrated in FIG. 4.

One or more therapeutic compositions are applied to or incorporated in sleeve 11 and/or mitt 10. The compositions can be in liquid, gas, and/or solid form. The presently preferred therapeutic compositions consist of aqueous aroma therapy solutions. Each aroma therapy solution includes one or more flower essences selected based on the disposition of the animal. A variety of animal dispositions can be addressed with therapeutic flower essences, including, without limitation, grief, jealousy, rejection, abandonment, and stress. The particular four dispositions addressed herein in more detail are aggression, depression, anxiety, and contented. These dispositions and the use of sleeve 11 are set forth in more detail in FIG. 3.

In FIG. 3, a thin microfiber mitt sleeve is provided 40.

An aqueous therapeutic solution is provided 50. The presently preferred aqueous therapeutic solution is an aroma therapy solution. Any other therapeutic solution can be utilized.

Aggression by an animal comprises unprovoked and unjustified threatening or injurious behavior by an animal. These symptoms presume that the animal is physically healthy does not have a cold, flu, rabies, an injury, or some other physical illness that produces or causes the symptoms. If a first cat is being petted gently by its owner, and without cause elects to bite and claw the owner, that constitutes aggression. If a second cat is walking by minding its own business, and the first cat elects without cause to attack the second cat, that is aggression. On the other hand, if a mother cat attacks a dog that gets too close to her kittens, even if the dog obviously has no intention of harming the kittens, that is not aggression, that is the natural instinct of the mother cat to protect her young. The flower essences used to treat and reduce or eliminate aggression include bee balm, horehound, willow, holly, squash, yucca, and zinnia 51.

Depression by an animal occurs when the animal is lethargic and obviously does not partake in its normal activities. The animal won't eat, won't play with any enthusiasm, sits around, doesn't sleep well, and may “cry” in its sleep. These symptoms presume that the animal is physically healthy and does not have a cold, flu, injury or some other physical illness that produces or causes the symptoms. One event that can trigger depression of a cat, dog or other pet is having a member of the family leave: for example, when a youngster leaves for summer camp, college, to get married, etc. The flower essences used to treat and reduce or eliminate depression include blackberry, calendula, mustard, borage, gentian, and skullcap 53.

Anxiety by an animal occurs when the animal is abnormally hyperactive. The animal is nervous, may itch, tends not to stay put, won't sleep or won't sleep well, and, may pee in the house. A good example of anxiety occurs when a pet is anxious when it hears the thunder and other sounds produced during a thunderstorm. A dog, for instance, may refuse to sleep or lie during the storm, and to constantly walk around panting. These symptoms again presume that the animal is physically healthy and does not have a cold, flu, injury or some other physical illness that produces or causes the symptoms. The flower essences used to treat and reduce or eliminate anxiety include chamomile, aspen, impatiens, red and white chestnut, agrimony, and bottlebrush 52.

A contented disposition is the absence of anxiety, depression, and aggression. The feeling of well-being existing in a contented disposition is enhanced with the flower essences of blue penstemon, goldeneye, red poppy, saguaro, rosemary, and white walnut 54.

The flower essences prepared in accordance with one embodiment of the invention consist of aqueous aroma therapy solution consisting of 0.001% to 2% of the aroma essence or extract of a flower, and the remainder or substantially all of the remainder of the aqueous aroma therapy solution consisting of water. An aroma essence or extract is a composition that has the fundamental properties of a substance in a concentrated form. Minor effective amounts of fragrances, surfactants, stabilizers, preservatives, or other compositions can, if desired, be incorporated in the aqueous solution, but it presently is preferred that the aqueous solution comprise only water and one or more selected flower essences. The concentration of active ingredients in an aroma essence can vary, but 0.001% to 2% by weight of the aroma essence is, as noted, combined with water to form an aqueous aroma therapy solution. An aroma essence typically is an aqueous solution of one to eight percent alcohol and includes extracts from one to eight fresh flowers.

If an aroma essence includes alcohol, the alcohol may or may not be allowed to evaporate from the resulting aqueous aroma therapy solution. The volume of alcohol (and water) lost during this evaporation process is replaced with water to return the aqueous aroma therapy solution to its original volume.

The aqueous aroma therapy solution is sprayed or misted 55 (FIG. 3) on to sleeve 11 and/or mitt 10 and is allowed to dry 56. The quantity of aqueous aroma therapy solution misted on to sleeve 11 or mitt 10 can vary as desired, but typically only a small quantity is required, i.e., one or two pumps from a spray bottle or a short “blast” of mist from automated misting equipment. The aroma therapy solution or another desired solution can be misted on or otherwise applied to or in a sleeve 11 or mitt 10 at any desired time. For example, the solution can be applied during manufacture and before a consumer purchases the sleeve 11 or mitt 10, or, the solution can be applied by a consumer after the consumer purchases a sleeve 11 or mitt 10. The solution can be sold to a consumer is a spray dispenser.

At some point in time after the aqueous aroma therapy solution drys, the sleeve 11 is slipped on mitt 10 to the position indicated in FIG. 1 by dashed lines 11A, and the mitt apparatus is used to groom an animal 57, after which the sleeve 11 can, if desired, be removed and discarded 58.

The shape of sleeve 11 and mitt 10 is important. Many animals have, as noted, been punished or abused by a human hand and view the approach of a human hand with trepidation. Consequently, the mitt 10 is preferably shaped like the paw of an animal, or has some shape other than the shape of a human hand in which the fingers of the hand are readily recognized. It definitely is not preferred to utilize a mitt that has separate stalls each shaped and dimensioned to relatively closely conform to and fit a finger of a human hand.

FIG. 1 illustrates the front side of mitt 10, including palm area 13 and toe areas 14, 15, 16, 17. Pad 39 is affixed to palm area 13. Pads 35 to 38 are affixed to toe areas 17 to 14, respectively. A vibrator unit 34 is mounted on the palm 13 beneath pad 39. Vibrator unit 30 is mounted on the toe area 17, typically but not necessarily beneath or adjacent pad 35. Vibrator unit 31 is mounted on toe area 16, typically beneath or adjacent pad 36. Vibrator 32 is mounted on toe area 15, typically beneath or adjacent pad 37. Vibrator 33 is mounted on toe area 14 beneath or adjacent pad 38. Pads 35 to 39 can comprise part of vibrators 30 to 34, respectively. Vibrators 30 to 34 can be operated simultaneously or individually or only a selected portion of vibrators 30 to 34 need be operated. While all of the toe areas 14 to 17 with vibrators can contact an animal simultaneously, only certain ones, and not all, of the toe areas need to be in contact with an animal at any give time. Each vibrator has, in conventional fashion, a power source that can comprise a battery, can comprise an electrical cord leading to a wall socket or other supply of electricity, and so on. One switch can be provided to turn on all of the vibrators at once, or multiple switches can be provided to turn on vibrators one at a time or in selected groupings. When a user's left hand is inserted palm up in the mitt 10 that is illustrated in FIG. 1, the thumb of the left hand extends under toe 17, the palm of the left hand is immediately under and contacts palm 13, and each vibrator 30 to 34 is positioned between the palm or at least one finger of the left hand and its associated pad 35 to 39. This is believed important in the mitt of the invention because an individual can use his fingertips to directly, gently, and independently vary the pressure of the vibrators 30 to 33 against the body of animal.

Mitt 10 includes internal ribs or partitions 18, 20, 21, 22 that define stalls for the fingers of a user's hand. If, for example, a user's left hand is inserted palm up into mitt 10 in FIG. 1 in the manner earlier described, the little finger (4^{th} finger) and 3^{rd} finger of the hand are in the stall extending between rib 18 and the side 19 of mitt 10; the middle finger (2^{nd} finger) is in the stall extending between ribs 20 and 21; the index finger (1^{st} finger) is in the stall extending between ribs 21 and 22; and, the thumb is in the stall extending between rib 22 and the side 23 of the mitt. The ribs or partitions 18, 20 to 22 can be formed by stitching together along a line the front (FIG. 1) and back 26 (FIG. 2) of the mitt 10; can be formed by inserting and securing inside mitt 10 long thin panel members; or can be formed in any other desired manner. Each partition 20 to 22 need not be continuous and can consist of spaced apart sections. Each partitions can be substantially rigid, but typically is flexible to facilitate opening and closing and manipulating by a user's fingers of the mitt 10. Defining stalls inside mitt 10 is important in the practice of the invention because it facilitates independent movement of the fingers and facilitates maintaining the user's fingertips in position behind their associated vibrator 30 to 33 during use of the mitt. Vibrator 34 ordinarily, but not necessarily, is larger than vibrators 30 to 33 and is important in increasing the area of an animal's body that is subjected to vibration.

In use, mitt sleeve 11 is inserted over mitt 10 to the orientation indicated by dashed lines 11A in FIG. 1. A user's hand is slipped into mitt 10 in the manner illustrated in FIG. 2, the vibrators 30 to 34 are (if desired) turned on, and the front of the mitt is gently pressed against the body of a cat 26 or other animal. The user gently kneads the cat's body by bending and moving his fingers and palm inside mitt 10. When the mitt 10 and mitt sleeve 11 (mitt 10 can, if desired, be utilized without sleeve 11) are moved over the fur on the body of the animal 26, sleeve collects loose fur, as well as dirt and grease. Massaging animal 26 with mitt 10 stimulates oil glands associated with the fur and gives the fur a desirable sheen. Mitt 10 is shown in FIG. 2 without sleeve 11.

The frequency of sound produced by the vibrator(s) 30 to 34 is important and depends on the particular kind of animal being groomed. A lower frequency range, typically in the range 220 Hz to 2349.32 Hz, is preferred for a cat. This range is, by way of example and not limitation, represented on a piano by the note A3 (220.00 Hz, 557 cm wavelength) to D7 (2349.32 Hz, 14.7 cm wavelength). Shorter or longer frequencies outside this range are more likely to irritate a cat. A higher frequency, typically in the range of 65.41 Hz to 2093.00 Hz is preferred for a dog. This range is, by way of example and not limitation, represented on a piano by the notes C2 (65.41 Hz, 527 cm wavelength) to C7 (2093.00 Hz, 16.5 cm wavelength). Shorter or longer frequencies outside this range are more likely to irritate a dog. Desirable frequencies for other domesticated animals and other animals can normally can be identified with minimal experimentation. Similarly, the amplitude of the sound produced by the vibrator(s) is important. A sound that is too loud will frighten or irritate an animal. It is preferred that the amplitude of sound produced by vibrators be less than sixty decibels. As used herein, the amplitude, frequency, and/or composition of a sound produced at or adjacent an animal's body is appealing if it does not cause the animal to leave the vicinity of the sound or to try to get away from the sound. As used herein, the amplitude, frequency, and/or composition of a sound produced at or adjacent an animal's body is soothing if it attracts the animal. If, for example, a cat on hearing the sound begins to purr or to play with or rub against the source of the sound, then the sound is soothing to the cat. If, for example, a dog on hearing the sound lays near or against the source of the sound, then the sound is soothing to the dog. The sound produced by the mitt apparatus need not be produced by a vibrator 30 to 34. A sound generating module can be mounted on the mitt apparatus and can produce sound in combination or in place of (the vibrator may, practically speaking, be “silent”) sound produced by a vibrator 30 to 34. The sound generating module can produce melodies of songs, singer's voices, orchestral music, or any other desired kind of music or audible sound. An external sound source can also be utilized in combination with the mitt apparatus of the invention. The external source could, for example, comprise a CD player, a radio, an individual or group singing or humming, etc.

If desired, sound produced by the external source can be utilized in combination with sound produced by the sound module. One way this is accomplished is to produce sound with the external source simultaneously with sound produced by the sound module. Another way it is accomplished is to produce sound with the external source before or after sound is produced by the sound module. A further way it is accomplished is do both, i.e. to produce sound with the external source simultaneously with sound produced by the module and to produce sound at a time or times when sound is not being produced by the sound module.

The sound produced by the sound generating module or by the external sound source preferably, but not necessarily, is, however, appealing or soothing to the animal being groomed with mitt 10. Similarly, the scents (if any) produced by the flower essences on sleeve 11 or mitt 10 preferably, but not necessarily, are appealing or soothing to the animal being groomed. The aqueous aroma therapy solutions described herein do have scents.

As used herein, the terms “fur” or “fur coat” refer to a coat of hair on an animal. The coat of hair can consist of a single layer of hair that partially or substantially completely covers the animal. The coat of hair can also consist of multiple layers or kinds of hair. For example, a coat of fur can include a layer of oily guard hair and layer of thicker underfur beneath the layer of guard hair. The guard hair functions to shed moisture. The underfur functions as an insulating blanket that keeps the animal warm. In some case, animals have several or many hairs per follicle. Examples of animals with fur coats are, without limitation, set forth below in Table I.

TABLE I
Animals with Fur Coats

| Animal | Family | Description of Fur |
|---|---|---|
| Beaver | Rodent | Dark brown; short, thick fur |
| Chihuahua | Dog | Brown; short fur |
| Chinchilla | Rodent | Blue-gray; long, branched, fine fur |
| Coyote | Dog | Gray, yellow-gray, tan; long thick fur |
| Ermine | Weasel | White, black; short, thick fur |
| Fisher | Weasel | Dark brown; short, soft fur |
| Fitch | Weasel | Yellow, beige, brown, black; long, silky fur |
| Fox | Dog | Red, blue, silver, white; long, soft fur |
| Greyhound | Dog | White, grey, black, brown; short fur |
| Lynx | Cat | Beige, white; long silky fur |
| Maltese | Dog | White; long fur |
| Marine coon | Cat | Dark brown; long fur |
| Marten | Weasel | Blue-brown; soft, thick fur |
| Opossum | Opossum | Creamy; short, rough fur |
| Persian lamb | Sheep | Black, brown, gray; wooly, tightly curled fur |
| Rex | Cat | White gray; short fur |
| Russian blue | Cat | Blue gray; short fur |
| Seal | Seal | Gray, salmon, silver, white; short, silky or stiff |
| | | fur |
| Sphynx | Dog | Short, downy, almost invisible fur. |
| Squirrel | Rodent | Gray; short, soft fur. |

A human being is not considered an animal for purposes of the invention. The mitt apparatus of the invention is specifically designed for and intended for animals other than human beings. Although it is believed that the invention likely can be advantageously used with care on all or nearly all animals, the presently anticipated present primary use of the invention is in connection with popular domesticated four legged animals that have a fur coat; namely, cats, dogs, and horses.

Having described our invention in such terms as to enable those of skill in the art to make and practice it, and having described the presently preferred embodiments thereof, we claim:

1. A therapeutic device to appeal to multiple physical senses of an animal that has a fur coat, the device comprising
(a) a paw-shaped mitt apparatus;
(b) at least one vibrator mounted on said mitt apparatus to produce vibrations detectable by the animal when said mitt apparatus is placed against the animal;
(c) at least one audio device mounted on said mitt apparatus to produce a sound having
(i) an amplitude that can be heard by the animal, and
(ii) an amplitude and frequency that is appealing to the animal;
(d) at least one scent on said mitt apparatus that can be smelled by the animal and that functions to perform at least one function in a group consisting of
(i) reducing aggressive behavior of the animal,
(ii) reducing depression of the animal, and
(iii) reducing anxiety of the animal.

2. A therapeutic device for an animal that has a fur coat, the device comprising
(a) a paw-shaped mitt apparatus including
(i) a front including a palm area and a plurality of toe areas, and
(ii) a back;
(b) at least one vibrator mounted on said mitt adjacent one of said toe areas;
(c) at least one vibrator mounted on said mitt adjacent said palm area; and,
(d) ribs in said mitt defining stalls for at least one finger on the hand of a human being.

3. A therapeutic device to appeal to multiple physical senses of an animal that has a fur coat, the device comprising
(a) a paw-shaped mitt apparatus including a removable thin outer microfiber sleeve, said sleeve
(i) when dry,
attracting fur by electric charge,
including tiny microfiber ends that loosen dirt from an animal's fur, and
absorbing up to four times its weight in dirt, grease, and liquid,
(ii) when damp,
absorbing dirt, grease and liquid by capillary force,
including tiny microfiber ends that loosen dirt from an animal's fur, and
absorbing up to four times its weight in diret, grease, and liquid, and;
(iii) comprised of fibers less than one denier; and,
(b) at least one scent on said mitt apparatus that can be smelled by the animal and that functions to perform at least one function in a group consisting of
(i) reducing aggressive behavior of the animal,
(ii) reducing depression of the animal, and
(iii) reducing anxiety of the animal.
